(19) United States
(12) Patent Application Publication
(10) Pub. No.: US 2012/0063375 A1
(43) Pub. Date: Mar. 15, 2012

(54) Radio Resource Scheduling Method, Apparatus, and System

(75) Inventors: Zhaojie Zhou, Shanghai (CN); Qi Liu, Shanghai (CN)

(73) Assignee: HUAWEI TECHNOLOGIES CO., LTD., Shenzhen (CN)

(21) Appl. No.: 13/298,921

(22) Filed: Nov. 17, 2011

Related U.S. Application Data
(63) Continuation of application No. 13/024,625, filed on Feb. 10, 2011.
Application No. 13/024,625 is a continuation of application No. PCT/CN2009/073137, filed on Aug. 7, 2009.

(30) Foreign Application Priority Data
Aug. 12, 2008 (CN) 200810142343.6

(51) Int. Cl. H04W 72/04; H04J 1/00

(52) U.S. Cl. 370/281

(57) ABSTRACT

Method, apparatus and system for radio resource scheduling are provided. In a case that two or more absolute grant (AG) tables exist, a base station obtains an indication sent by a base station control node for indicating which AG table among the two or more AG tables is used by the base station. The AG table used by the base station as indicated in the indication is the same as an AG table used by a User Equipment (UE). The base station performs High Speed Uplink Packet Access (HSUPA) radio resource scheduling for the UE according to the received indication sent by the base station control node.

This application is a continuation of U.S. patent application Ser. No. 13/024,625, filed on Feb. 10, 2011, which is a continuation of International Application No. PCT/CN2009/073137, filed on Aug. 7, 2009 and which claims priority to Chinese Patent Application No. 200810142343.6, filed on Aug. 12, 2008, each of which is incorporated herein by reference in its entirety.

### TECHNICAL FIELD

The present invention relates to the field of wireless communication, and more particularly to a method, apparatus and system for radio resource scheduling.

### BACKGROUND

High Speed Uplink Packet Access (HSUPA) is an uplink enhancement technology on a wireless side introduced by the 3rd Generation Partnership Project (3GPP) protocol system in R6 version. The HSUPA accomplishes a high-rate uplink data transmission function by rapid retransmission, Hybrid Automatic Retransmission Request (HARM), and base station-based distributed control methods. In the HSUPA, five new types of physical channels, namely, Enhanced-Dedicated Physical Data Channel (E-DPDCH), Enhanced-Dedicated Physical Control Channel (E-DPCCH), Enhanced-Absolute Grant Channel (E-AGCH), Enhanced-Relative Grant Channel (E-RGCH), Enhanced-HARQ Acknowledgement Indicator Channel (E-HICH), and two new Media Access Control (MAC) entities, namely, MAC-e and MAC-es, are introduced. In the HSUPA, a packet scheduling function is moved downwards from a base station controller to a base station, thereby achieving rapid packet scheduling based on the base station; and a maximum uplink data throughput being up to 5.76 Mbit/s is achieved by key technologies, such as short 2 ms radio frames and multi-code transmission. Therefore, the uplink data service bearer capability is greatly improved in the HSUPA.

The 3GPP protocol defines an Absolute Grant (AG) table for indicating index values of different grants. A grant process is described in the following. The network side looks up an AG table according to a grant to obtain an index value of the grant, and then transmits the index value of the grant to a User Equipment (UE). The UE looks up an AG table at the UE according to the index value and obtain an AG value. It can be known from the granting process that, both the network side and the UE side require an AG table.

However, it is found that the prior art above at least has the following defect. In a certain case, the network side and the UE side may have different understandings about the AG used, and thus results in inconsistent or error about the AG grant between the network side and the UE side.

It should be noted that, the above description of the prior art and defects thereof is merely illustrated by taking a Wideband Code Division Multiple Access (WCDMA) system as an example. It should be understood that, in other communication systems, especially in a Time Division-Synchronous Code Division Multiple Access (TD-SCDMA) system, similar problems also exist.

### SUMMARY OF THE INVENTION

Embodiments of the present invention are directed to a method, apparatus and system for radio resource scheduling, capable of ensuring that a network side and a UE side have the same understanding about grant information, thereby ensuring correct scheduling of radio resources.

In an embodiment of the present invention, a radio resource scheduling method is provided.

In a case that two or more AG tables exist, a base station obtains an indication sent by a base station control node for indicating which AG table among the two or more AG tables is used by the base station. The AG table used by the base station as indicated in the indication is the same as an AG table used by a UE. The base station can perform HSUPA radio resource scheduling for the UE according to the received indication sent by the base station control node.

In another embodiment, the present invention provides a base station of a radio resource scheduling system. The base station includes an indication acquisition unit and a scheduling unit.

The indication acquisition unit is configured to obtain an indication sent by a base station control node for indicating which AG table among two or more AG tables is used by the base station. The AG table used by the base station as indicated in the indication is the same as an AG table used by a UE.

The scheduling unit is configured to perform HSUPA radio resource scheduling for the UE according to the indication sent by the base station control node and obtained by the indication acquisition unit.

In still another embodiment, the present invention provides a base station control node in a radio resource scheduling system. Two or more AG tables exist in the system. The base station control node includes a first indication unit and a second indication unit. The first indication unit is configured to send a first indication to a base station, so as to indicate which AG table among the two or more AG tables is used by the base station. The second indication unit is configured to send a second indication to a User Equipment (UE), so as to indicate which AG table among the two or more AG tables is used by the UE. The AG table used by the base station as indicated in the first indication is the same as the AG table used by the UE as indicated in the second indication.

In yet still another embodiment, the present invention provides a radio resource scheduling system, which includes the described base station, and the described base station control node.

As can be known from the technical solutions, in the embodiments of the present invention, in a case that there are two or more AG tables, a base station obtains an indication sent by a base station control node for indicating which AG table among two or more AG tables is used by the base station. The AG table used by the base station as indicated in the indication may be the same as an AG table used by a UE. Then, the base station performs a HSUPA radio resource scheduling for the UE according to the received indication sent by the base station control node. Through such technical solutions, it is ensured that the network side and the UE side have the same understanding about the granting information, thereby ensuring correct scheduling of radio resources.

### BRIEF DESCRIPTION OF THE DRAWINGS

FIG. 1 is a flowchart of a radio resource scheduling method according to an embodiment of the present invention;

FIG. 2 is a schematic flowchart of another radio resource scheduling method according to an embodiment of the present invention;

FIG. 3 is a schematic block diagram of a base station in a radio resource scheduling system according to an embodiment of the present invention; and

FIG. 4 is a schematic block diagram of a base station control node in a radio resource scheduling system according to an embodiment of the present invention.

### DETAILED DESCRIPTION OF ILLUSTRATIVE EMBODIMENTS

In order to make the objectives, technical solutions, and advantages of the present invention more comprehensible, the present invention is further described in detail below with reference to the accompanying drawings. It should be noted that, the illustrations of embodiments are mainly given below by taking a WCDMA system as an example, which is not intended to limit the application of the technical solutions of the present invention in other systems.

As described above, the HSUPA technology is introduced by the 3GPP standard in R6 version which defines an Absolute Grant (AG) table. With the evolution of technology, a new AG table is additionally defined by the 3GPP standard in R7 version. As a result, together with the AG table defined in the R6, there are two AG tables after the R7 version. Since two AG tables exist, it needs to choose which AG table is to be used when AG commands are received and sent. Further, it should be understood that, with the evolution of technology, more AG tables may exist.

In the technical solutions of the present invention, in a case that two or more AG tables exist, a base station obtains an indication sent by a base station control node for indicating which AG table among two or more AG tables is used by the base station. In addition, the AG table used by the base station as indicated in the indication may be the same as an AG table used by a UE. Then, the base station performs HSUPA radio resource scheduling for the UE according to the received indication sent by the base station control node.

The technical solutions of the present invention are described in detail below through embodiments.

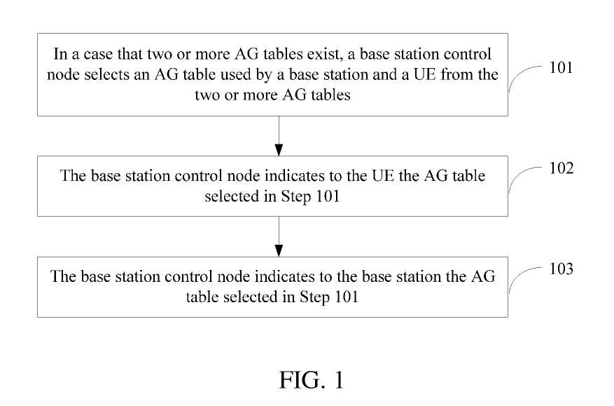

In a first embodiment, the present invention provides a radio resource scheduling method. FIG. 1 is a schematic flow chart of a radio resource scheduling method according to an embodiment of the present invention. Referring to FIG. 1, the method includes the following steps.

In Step 101, in a case that two or more AG tables exist, a base station control node selects an AG table used by a base station and a UE from the two or more AG tables.

In this embodiment, taking a WCDMA system as an example, the base station control node may be a Radio Network Controller (RNC). The RNC is a device in a radio network subsystem, mainly controls the use and integrity of radio resources, and may implement the selection or configuration of the AG table used by the base station and the UE.

It should be noted that, as for the number of the AG tables that may be selected by the base station control node, in the case that R6 and R7 each have an AG table (respectively referred to as AG table 1 and AG table 2), the number is 2. However, with the evolution of technology, more AG tables may exist, which is not limited by the technical solutions of the present invention.

In Step 102, the base station control node indicates to the UE the AG table selected in Step 101.

In this step, the base station control node may indicate to the UE the selection result of Step 101 in many manners, for example, through a Radio Resource Control (RRC) signaling between the RNC and the UE. In this manner, a signaling may be used, or a newly defined information element (IE) may be used. If a newly defined IE is added, the newly defined IE may be named “BetaEd gain E-AGCH table selection,” for the RNC to indicate to the UE which AG table to use.

In Step 103, the base station control node indicates to the base station the AG table selected in Step 101.

In the case that Step 102 has explicitly indicated the AG table used by the UE, if the base station is not indicated which AG table is used by the base station, the AG table used by the base station may be different from the AG table used by the UE, such that HSUPA scheduling cannot be normally performed. Therefore, it needs to indicate which AG table is used by the base station.

In this step, the base station control node may also indicate to the base station the selection result of Step 101 in many manners, for example, by adding an IE or a signaling for indicating the AG table used by the base station in a configuration signaling between the base station control node and the base station.

The indicating manner in Step 103 is described in detail below through an embodiment.

A first example of indicating as described in Step 103 is to add information for indicating AG table choice into the existing message information. The information may be embodied in the form of an IE, and examples are given below.

In a first example, an IE for indicating AG table choice is added in E-DCH FDD Information IE (the E-DCH FDD Information provides information required for E-DCH setup). The IE for indicating AG table choice may be named E-AGCH Table Choice IE. The E-DCH FDD Information IE with the added E-AGCH IE is as shown in Table 1.

TABLE 1
E-DCH FDD Information

| IE/Group | | | IE Type and | Semantics | | Assigned |
|---|---|---|---|---|---|---|
| Name | Presence | Range | Reference | Description | Criticality | Criticality |
| E-DCH | M | | 9.2.2.13M | | — | |
| MAC-d Flows | | | | | | |
| Information | | | | | | |
| HARQ Process | O | | HARQ Process | If this IE is not | — | |
| Allocation | | | Allocation for | included, scheduled | | |
| For 2 ms | | | 2 ms TTI | transmission in all | | |
| Scheduled | | | 9.2.2.13Dn | HARQ processes is | | |
| Transmission | | | | allowed. | | |
| Grant | | | | | | |
| E-DCH Maximum | O | | 9.2.2.13T | | — | |
| Bitrate | | | | | | |
| E-DCH | O | | 9.2.1.79 | | — | |
| Processing | | | | | | |
| Overload | | | | | | |
| Level | | | | | | |
| E-DCH | O | | 9.2.2.13Y | | — | |
| Reference | | | | | | |
| Power Offset | | | | | | |
| E-DCH Power | O | | 9.2.1.85 | | YES | ignore |
| Offset for | | | | | | |
| Scheduling | | | | | | |
| Info | | | | | | |
| SixteenQAM | O | | 9.2.2.88A | | YES | reject |
| UL Operation | | | | | | |
| Indicator | | | | | | |
| E-AGCH | O | INTEGER | | | — | |
| Table Choice | | (0, 1) | | | | |

Table 1, “E-AGCH Table Choice” is the newly added IE for indicating the AG table choice. The E-AGCH Table Choice IE may be included in radio link setup, radio link addition, synchronous radio link reconfiguration, and asynchronous radio link reconfiguration procedures between the RNC and a NodeB. The E-AGCH Table Choice IE is sent by the RNC to the NodeB through a RADIO LINK SETUP signaling, a RADIO LINK ADDITION signaling, a RADIO LINK RECONFIGURATION PREPARE signaling, or a RADIO LINK RECONFIGURATION REQUEST signaling. When the NodeB obtains value of the E-AGCH Table Choice IE from the signaling, the NodeB needs to use an AG table indicated by the E-AGCH Table Choice IE in the process of sending granting information to the UE. Taking INTEGER (0, 1) in Table 1 as an example, when the indication is 0, it may represent that AG table 1 is selected, and when the indication is 1, it may represent that AG table 2 is selected. Of course, as the indication values may be set, 0 may be used to represent that the AG table 2 is selected, and 1 may be used to represent that the AG table 1 is selected. In addition, if more AG tables exist, other numerals may be set to represent the selection of corresponding AG tables. For example, INTEGER (0, 1, 2, 3) may be set, with 2 representing an AG table 3, and 3 representing an AG table 4. The specific representation is not limited in the present invention.

In a second example, an IE for indicating AG table choice is added in E-DCH FDD Information to modify IE (the E-DCH FDD Information to Modify provides information required for E-DCH update). Likewise, the IE may be named “E-AGCH Table Choice”. The E-DCH FDD Information to Modify with the added IE is as shown in Table 2 (for brevity, only a part of the E-DCH FDD Information to Modify IE is shown).

TABLE 2
E-DCH FDD Information to Modify

| IE/Group | | | IE Type and | Semantics | | Assigned |
|---|---|---|---|---|---|---|
| Name | Presence | Range | Reference | Description | Criticality | Criticality |
| >E-DCH | | 0 . . . <maxnooflogi- | | | — | |
| Logical | | calchannels> | | | | |
| Channel To | | | | | | |
| Delete | | | | | | |
| >>Logical | M | | 9.2.1.80 | | — | |
| Channel ID | | | | | | |
| HARQ Process | O | | HARQ Process | | — | |
| Allocation | | | Allocation for | | | |
| For 2 ms | | | 2 ms TTI | | | |
| Scheduled | | | 9.2.2.13Dn | | | |
| Transmission | | | | | | |
| Grant | | | | | | |
| E-DCH Maximum | O | | 9.2.2.13T | | — | |
| Bitrate | | | | | | |
| E-DCH | O | | 9.2.1.79 | | — | |
| Processing | | | | | | |
| Overload | | | | | | |
| Level | | | | | | |
| E-DCH | O | | 9.2.2.13Y | | — | |
| Reference | | | | | | |
| Power Offset | | | | | | |
| MAC-e Reset | O | | 9.2.1.83 | | — | |
| Indicator | | | | | | |
| E-DCH Power | O | | 9.2.1.85 | | YES | ignore |
| Offset for | | | | | | |
| Scheduling | | | | | | |
| Info | | | | | | |
| SixteenQAM | O | | 9.2.2.88A | | YES | reject |
| UL Operation | | | | | | |
| Indicator | | | | | | |
| E-AGCH | O | INTEGER | | | — | |
| Table Choice | | (0, 1) | | | | |
| E-DCH MAC-d | O | | 9.2.1.74B | | YES | reject |
| PDU Size | | | | | | |
| Format | | | | | | |

Table 2, the “E-AGCH Table Choice” is the newly added IE for indicating the AG table choice. The IE may be included in radio link setup, radio link addition, synchronous radio link reconfiguration and asynchronous radio link reconfiguration procedures between the RNC and the NodeB. The E-AGCH Table Choice IE is sent by the RNC to the NodeB through the RADIO LINK SETUP signaling, the RADIO LINK ADDITION signaling, the RADIO LINK RECONFIGURATION PREPARE signaling or the RADIO LINK RECONFIGURATION REQUEST signaling. When the NodeB acquires the value of E-AGCH Table Choice IE from the signaling, the NodeB needs to use the AG table indicated by the E-AGCH Table Choice IE in the sending granting information to the UE. Taking INTEGER (0, 1) in table 2 as an example, when the indication is 0, it may represent that the AG table 1 is selected, and when the indication is 1, it may represent that the AG table 2 is selected. Of course, depending on the set of the indication value, 0 may be used to represent that the AG table 2 is selected, and 1 may be used to represent that the AG table 1 is selected.

It should be noted that, the description of specific IE is merely an example, and a variety of other information may also be used, which is not limited by the present invention.

In addition, it should be noted that, in a conventional UMTS architecture, the IE for AG table choice may be transmitted through an lub interface (an interface between the RNC and the NodeB).

In the technical solution of this embodiment, an IE for indicating AG table choice is used in the signaling sent by the base station control node, and the base station receives the IE for indicating AG table choice from the signaling, so as to obtain which AG table is used.

A second example of indicating as described in Step 103 is to add a new signaling. That is, a signaling is added to indicate the selected AG table into a configuration signaling of the RNC and the NodeB.

The 3GPP 25.433 defines NodeB Application Part (NBAP) signaling exchange between the RNC and the NodeB. All information of the NodeB that needs to be configured by the RNC may be configured by the RNC for the NodeB through an NBAP signaling. Therefore, an NBAP signaling may be added to indicate the selected AG table (that is, the AG table used by the base station NodeB).

As such, if the NodeB receives the NBAP signaling, the NodeB can know the AG table to be used thereby after parsing the NBAP signaling.

If the technical solutions of the present invention are applied in a HSUPA scenario of a WCDMA system, the problem that the NodeB and the UE use different AG tables can be solved, so as to ensure the normal operation of HSUPA scheduling, thereby improving the operational stability of the HSUPA system.

If the technical solutions of the present invention are applied in other systems, especially TD-SCDMA systems, the problem that the base station and the UE use different AG tables can also be solved, so as to ensure the normal operation of radio resource scheduling, thereby improving the operational stability of the system.

In addition, based on the existing information, the existing signaling and signaling processes may be directly used by adding an IE, thereby solving the problem in the prior art with a low overhead.

A third embodiment will now be described.

In addition to the manners that the base station control node selects an AG table and then indicates the selected AG table to the base station and the UE, “agreeing on an AG using relation” may also be adopted, so as to achieve consistency between the AG tables used by the network side and the AG table used by the UE side. Specifically, an AG using relation may be agreed on, such that the use of AG tables is determined according to other configurations. For example, a corresponding relation between AG tables and application scenarios may be established, so as to realize the same understanding of the network side and the UE side about the grant by pre-configuration.

The manner that the base station control node sends an indication to the base station may also be adopted. For example, the base station control node sends the following indication to the base station: indicating the base station whether to enable a particular Quadrature Amplitude Modulation (QAM) mode for a current wireless connection. If the indication indicates the enabling of the particular QAM mode, it indicates that the base station uses an AG table corresponding to the enabled particular QAM mode. It should be noted that, the particular QAM mode may include 16QAM introduced in the R7 version, or other particular QAM modes corresponding to other protocol versions.

Specifically, the coexistence of the R6 version and the R7 version is taken as an example. The R6 version defines the AG table 1. Since 16QAM is introduced in the R7 version, the AG table 2 is also defined. Therefore, the following binding relation may be configured. The AG table 1 can only be used in a scenario without 16QAM configuration, and the AG table 2 can only be used in a scenario with 16QAM configuration.

According to the existing protocol, the RNC may indicate to the NodeB whether to enable 16QAM for a current wireless connection through SixteenQAM UL Operation Indicator IE. The IE may be carried in a synchronous radio link reconfiguration message or asynchronous radio link reconfiguration message. When the NodeB applies 16QAM, the AG table 2 is used; otherwise, the AG table 1 is used.

By agreeing on an AG using relation such that the use of AG tables is determined according to other configurations (for example, indicating whether to use a particular QAM mode), the existing signaling and signaling processes may be directly used by adding an IE, thereby solving the problem in the prior art with a low overhead.

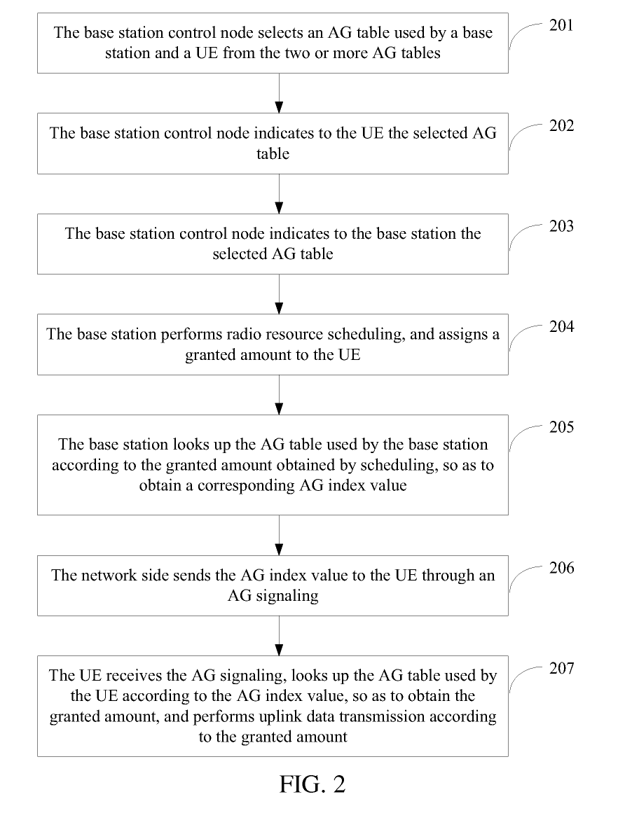

In order to make the solutions of the present invention more comprehensible, an embodiment (the fourth embodiment) of the present invention is described through a complete uplink scheduling process by still taking HSUPA of a WCDMA system as an example with reference to FIG. 2. FIG. 2 is a schematic flowchart of another radio resource scheduling method according to an embodiment of the present invention. Referring to FIG. 2, the method includes the following steps.

In Step 201, the base station control node selects an AG table used by a base station and a UE from the two or more AG tables. This step is similar to Step 101, so the details will not be described herein again.

In Step 202, the base station control node indicates to the UE the selected AG. This step is similar to Step 102, so the details will not be described herein again.

In Step 203, the base station control node indicates the selected AG to the base station. This step is similar to Step 103, so the details will not be described herein again.

In addition, “agreeing on an AG using relation” may also be adopted, so as to replace Step 201 to Step 203.

After the base station and UE knows the AG table used thereby, the following radio resource scheduling process may be performed.

In Step 204, the base station performs radio resource scheduling, and assigns a granted amount to the UE.

During uplink HSUPA scheduling, the uplink transmission scheduling is accomplished by the base station by assigning a grant to the UE. For example, the base station may measure an uplink air interface load, and performs scheduling according to the status of the uplink air interface load. When the uplink load is high, the base station may reduce the granted amount assigned to the UE; on the contrary, when the uplink load is low, the base station may increase the granted amount assigned to the UE. In addition, the base station may also assign the granted amount to the UE according to a happy status reported by the UE and/or a priority level of the UE, for example, the UE having a high priority level may obtain a large granted amount, or the UE whose happy status reported is unhappy may obtain a large granted amount. Alternatively, the base station fully considers the uplink air interface load, the happy status reported by the UE, and the priority level of the UE, and thus fully considers how to assign the grant to the UE.

In Step 205, the base station looks up the AG table used by the base station according to the granted amount assigned, so as to obtain a corresponding AG index value.

In Step 206, the network side sends the AG index value to the UE through an AG signaling.

This step may be performed by the base station on the network side. For example, the base station transmits an AG signaling through a granting channel, and sends the AG index value to the UE through the AG signaling, thereby assigning granting information to the UE. For example, the base station may transmit an AG signaling through an E-AGCH channel, so as to assign AG information to the UE. The AG information may be the AG index value determined in Step 205. The AG signaling is absolute grant, and means that a certain grant value is directly assigned to the UE, and the UE subsequently calculates transmission rate and transmission power according to the new grant value.

In addition, the base station may also transmit a Relative Grant (RG) signaling through an E-RGCH channel, so as to assign RG information to the UE. The RG signaling is relative grant, and means that the grant value to the UE is adjusted based on the current grant.

As for the specific transmission method of the AG information, the base station may transmit an AG signaling index value through an E-AGCH channel.

In Step 207, the UE receives the AG signaling, looks up the AG table used by the UE according to the AG index value, so as to obtain a granted amount, and performs uplink data transmission according to the granted amount.

The UE has received the indication and known the AG table to be used thereby in the previous steps. Therefore, in this step, after receiving the AG signaling, the UE looks up the corresponding AG table according to the AG signaling index value in the AG signaling, so as to obtain a granted amount, and uses the granted amount as a current grant value. If the granted amount already exists, the newly obtained granted amount is used to update the original granted amount, and thus used as a new current granted amount. The UE needs to calculate the transmission power and maximum transmission rate according to the current granted amount, and perform uplink data transmission.

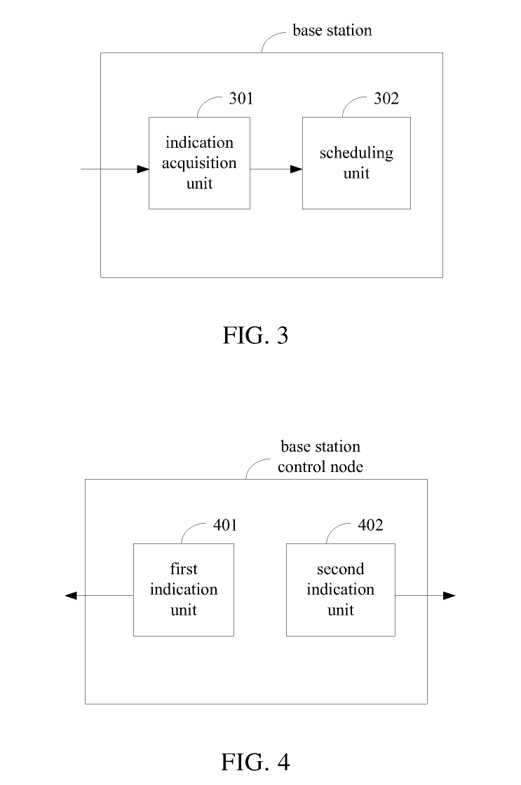

In another embodiment, the present invention further provides a base station of a radio resource scheduling system, which is described below with reference to FIG. 3. FIG. 3 is a schematic block diagram of a base station according to an embodiment of the present invention.

By taking a WCDMA system as an example, two or more AG tables may exist in the system due to multiple versions.

In this case, the base station may include an indication acquisition unit 301 and a scheduling unit 302. The indication acquisition unit 301 is configured to obtain an indication sent by a base station control node for indicating which AG table among the two or more AG tables is used by the base station, in which the AG table used by the base station as indicated in the indication is the same as an AG table used by a UE. The scheduling unit 302 is configured to perform HSUPA radio resource scheduling for the UE according to the indication sent by the base station control node and obtained by the indication acquisition unit 301.

Specifically, according to different indications used in the technical solutions, the function of acquiring indication information of the indication acquisition unit 301 may be implemented by different subunits.

For example, the used indication may be a signaling sent by the base station control node (for example, to the base station), an IE for indicating AG table choice is used in the signaling, and the base station receives the IE for indicating AG table choice, so as to obtain the indication for indicating which AG table is used. In this manner, the indication acquisition unit may include a first subunit (not shown in the Figures), configured to receive the signaling sent by the base station control node. Since an IE for indicating AG table choice is used in the signaling, and the IE indicates which AG table among the two or more AG tables is used by the base station, the first subunit can obtain the indication for indicating which AG table is used.

For another example, the used indication may be an indication that the base station control node indicates to the base station whether to enable a particular QAM mode for a current wireless connection, and if the indication indicates the enabling of the particular QAM mode, it indicates that the base station uses an AG table corresponding to the enabled particular QAM mode. In this manner, the indication acquisition unit may include a second subunit (not shown in the Figures), configured to receive the indication that the base station control node indicates to the base station whether to enable the particular QAM mode for the current wireless connection. Since whether to enable the particular QAM mode can indicate whether the base station needs to use the AG table corresponding to the enabled particular QAM mode, the second subunit can obtain the indication for indicating which AG table is used.

In addition, the scheduling unit 302 of the base station may also be accomplished through more detailed units. For example, the scheduling unit 302 may include a third subunit that is configured to assign a granted amount to the UE. A fourth subunit is configured to look up the AG table used by the base station according to the granted amount assigned by the third subunit, so as to obtain a corresponding AG index value. A fifth subunit is configured to send the AG index value obtained by the fourth subunit to the UE through an AG signaling.

Further, the base station may further include other unit modules, so as to implement the steps completed by the base station in the corresponding method embodiments.

In still another embodiment, the present invention further provides a base station control node in a radio resource scheduling system, which is described below with reference to FIG. 4. FIG. 4 is a schematic block diagram of a base station control node of a radio resource scheduling system according to an embodiment of the present invention.

By taking a WCDMA system as an example, two or more AG tables may exist in the system due to multiple versions.

In this case, the base station control node may include a first indication unit 401 and a second indication unit 402. The first indication unit 401 is configured to send a first indication to a base station, so as to indicate which AG table among the two or more AG tables is used by the base station. The second indication unit 402 is configured to send a second indication to a User Equipment (UE), so as to indicate which AG table among the two or more AG tables is used by the UE. The AG table used by the base station as indicated in the first indication is the same as the AG table used by the UE as indicated in the second indication.

Specifically, the indications used in the technical solutions of the present invention may be in various forms. For example, the first indication is a signaling sent by the base station control node (for example, a signaling send by the base station control node to the base station), an IE for indicating AG table choice is used in the signaling, and the IE indicates which AG table among the two or more AG tables is used by the base station. Alternatively, the first indication is an indication that the base station control node indicates to the base station whether to enable a particular QAM mode for a current wireless connection, and if the indication indicates the enabling of the particular QAM mode, it indicates (or shows) that the base station uses an AG table corresponding to the enabled particular QAM mode.

In addition, the base station control node may further include other unit modules, so as to implement the steps completed by the base station control node in the corresponding method embodiments.

In addition, in an embodiment, the present invention further provides a radio resource scheduling system, which includes the described base station, and the described base station control node. Since the base station and the base station control node have been described in detail above, the details will not be described herein again.

Through the technical solutions of the present invention, in a case that two or more AG tables exist, a base station obtains an indication sent by a base station control node for indicating which AG table among two or more AG tables is used by the base station. The AG table used by the base station as indicated in the indication may be the same as an AG table used by a UE. Then, the base station performs HSUPA radio resource scheduling for the UE according to the received indication sent by the base station control node. Through such technical solutions, it can be ensured that the network side and the UE side have the same understanding about the granting information, thereby ensuring correct scheduling of radio resources.

If the technical solutions of the present invention are applied in a HSUPA scenario of a WCDMA system, the problem that the NodeB and the UE use different AG tables can be solved, so as to ensure the normal operation of HSUPA scheduling, thereby improving the operational stability of the HSUPA system.

If the technical solutions of the present invention are applied in other systems, especially TD-SCDMA systems, the problem that the NodeB and the UE use different AG tables can also be solved, so as to ensure the normal operation of radio resource scheduling, thereby improving the operational stability of the system.

It should be noted that the embodiments are described by taking a WCDMA system as an example. It should be understood that, the technical solutions of the present invention may also be applied in other systems, especially TD-SCDMA systems. In the systems, the term “base station” has different names. For example, NodeB in WCDMA and TD-SCDMA systems, may be referred to as a “base station.” In addition, RNC in WCDMA and TD-SCDMA systems may be referred to as a “base station control node.”

In the present invention, the term “receive” may be either construed as actively acquiring information from other modules, or construed as receiving information sent by other modules.

It should be understood by persons skilled in the art that the accompanying drawings are merely schematic views of a preferred embodiment, and modules or processes in the accompanying drawings are not necessarily required in implementing the present invention.

Persons of ordinary skill in the art should understand that all or a part of the steps in the method according to the embodiments of the present invention can be implemented by a program instructing relevant hardware, and the program may be stored in a computer readable storage medium. When the program is run, one or a combination of the steps of the method according to the embodiments of the present invention are performed.

In addition, the functional units in the embodiments of the present invention may either be integrated in a processing module, or each be a separate physical unit. Alternatively, two or more of the units can be integrated in one module. The integrated modules may be implemented in the form of hardware or software functional modules. If implemented in the form of software functional modules and sold or used as an independent product, the integrated modules may also be stored in a computer readable storage medium.

The storage medium may be a Read-Only Memory (ROM), a magnetic disk or a Compact Disk Read-Only Memory (CD-ROM).

The above descriptions are merely preferred embodiments of the present invention, but not intended to limit the scope of the present invention. Any modifications, variations or replacement that can be easily derived by those skilled in the art should fall within the scope of the present invention. Therefore, the protection scope of the present invention is subject to the appended claims.

What is claimed is:

1. A wireless communication system, comprising:
a base station control node; and
a base station;
wherein the base station control node is configured to send, through a signaling, an indication on absolute grant (AG) table choice to the base station;
wherein, the indication indicates which one among at least two AG tables is to be used by the base station;
wherein the indication is sent by being included in an Enhanced-Dedicated Channel (E-DCH) Frequency Division Duplex (FDD) Information (IE) of the signaling or a E-DCH FDD to modify IE of the signaling;
wherein the AG table to be used by the base station is consistent with an AG table to be used by a user equipment (UE); and
wherein the base station is configured to receive the indication on AG table choice, to obtain the indicated AG table to be used thereby, and to perform a High Speed Uplink Packet Access (HSUPA) radio resource scheduling for the UE according to the indicated AG table.

2. The system of claim 1, wherein the base station control node is configured to carry the indication by an IE of the E-DCH FDD information IE or that of the E-DCH FDD to modify information IE.

3. The system of claim 2, wherein the IE carrying the indication is an Enhanced-Absolute Grant Channel (E-AGCH) table choice IE.

4. The system of claim 1, wherein the signaling is any one of a RADIO LINK SETUP signaling, a RADIO LINK ADDITION signaling, a RADIO LINK RECONFIGURATION PREPARE signaling, or a RADIO LINK RECONFIGURATION REQUEST signaling.

5. The system of claim 1, wherein the at least two AG tables include an AG table corresponding to a sixteenth Quadrature Amplitude Modulation (16QAM) mode.

6. The system of claim 5, wherein, if the 16QAM mode is applied in the system, the indicated AG table is the AG table corresponding to the 16QAM mode.

7. The system of claim 1, wherein the base station is further configured to assign an absolute grant to the UE, to obtain an index corresponding to the assigned grant by looking up the indicated AG table, and to send the obtained index to the UE for uplink data transmission bases on the assigned grant.

8. The system of claim 1, wherein the base station control node comprises a radio network controller (RNC) and the base station comprises a Node B.

9. A method in a communication system, the method comprising:
sending an indication on absolute grant (AG) table choice from a base station control node to a base station, wherein the indication on AG table choice indicates which one among at least two AG tables is to be used by the base station, the indication being sent by being included in an information element (IE) of a signaling, wherein the IE including the indication is an Enhanced-Dedicated Channel (E-DCH) Frequency Division Duplex (FDD) IE (E-DCH FDD IE) or a E-DCH FDD to modify IE, and wherein the indicated AG table to be used by the base station is consistent with an AG table to be used by a user equipment (UE);
receiving, by the base station, the indication on AG table choice so that the base station obtains the indicated AG table; and
performing, by the base station, a High Speed Uplink Packet Access (HSUPA) radio resource scheduling for the UE according to the indicated AG table.

10. The method of claim 9, wherein the indication is sent to the base station by being carried by an IE of the E-DCH FDD information IE or that of the E-DCH FDD to modify information IE.

11. The method of claim 9, wherein the IE carrying the indication is an Enhanced-Absolute Grant Channel (E-AGCH) table choice IE.

12. The method of claim 9, wherein the signaling sent by the base station control node is any one of a RADIO LINK SETUP signaling, a RADIO LINK ADDITION signaling, a RADIO LINK RECONFIGURATION PREPARE signaling, or a RADIO LINK RECONFIGURATION REQUEST signaling.

13. The method of claim 9, wherein the at least two AG tables comprise an AG table corresponding to a sixteen Quadrature Amplitude Modulation (16QAM) mode.

14. The method of claim 13, wherein, if the 16 QAM mode is applied, the indicated AG table is the AG table corresponds to the 16 QAM mode.

15. The method of claim 9, wherein performing the HSUPA radio resource scheduling comprises:
assigning, by the base station, an absolute grant to the UE;
obtaining, by the base station, an index corresponding to the assigned grant by looking up the indicated AG table used by the base station; and
sending, by the base station, the obtained index to the UE for uplink data transmission based on the assigned grant.

16. The method of claim 9, wherein the base station control node is a radio wireless controller (RNC) and the base station is a NodeB.

17. A method in a communication system, comprising:
receiving, by a base station, an indication on absolute grant (AG) table choice from a base station control node, wherein the indication on AG table choice indicates which one among at least two AG tables is to be used by the base station, the indication received via an information element (IE) of a signaling, wherein the IE including the indication is an Enhanced-Dedicated Channel (E-DCH) Frequency Division Duplex (FDD) IE (E-DCH FDD IE) or a E-DCH FDD to modify IE, and wherein the indicated AG table to be used by the base station is consistent with an AG table to be used by a user equipment (UE);
obtaining, by the base station, the indicated AG table from the indication; and
performing, by the base station, a High Speed Uplink Packet Access (HSUPA) radio resource scheduling for the UE according to indicated the AG table.

18. The method of claim 17, wherein the signaling received by the base station is any one of a RADIO LINK SETUP signaling, a RADIO LINK ADDITION signaling, a RADIO LINK RECONFIGURATION PREPARE signaling, or a RADIO LINK RECONFIGURATION REQUEST signaling.

19. The method of claim 17, wherein the at least two AG tables comprise an AG table corresponding to a sixteen Quadrature Amplitude Modulation (16QAM) mode and wherein if the 16 QAM mode is applied, the indicated AG table is the AG table corresponding to the 16 QAM mode.

20. The method of claim 17, wherein the performing the HSUPA radio resource scheduling comprises:
assigning an absolute grant to the UE;
obtaining an index corresponding to the assigned grant by looking up the indicated AG table used by the base station; and
sending the obtained index to the UE for uplink data transmission based on the assigned grant.
